(19) United States
(12) Patent Application Publication
(10) Pub. No.: US 2004/0245292 A1
(43) Pub. Date: Dec. 9, 2004

(54) Container

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/890,963

(22) Filed: Jul. 13, 2004

Related U.S. Application Data
(62) Division of application No. 10/126,705, filed on Apr. 20, 2002, now Pat. No. 6,802,437.

(51) Int. Cl. B67D 5/42

(52) U.S. Cl. 222/387

(57) ABSTRACT

The container of the present invention stores viscous substances in a sealed environment and is easily transportable. The contents of the container can be easily extracted completely without any tools or contact with the user. The container is an elongated housing with one or more opening near its ends and with one or more piston with approximately the same profile and dimension as the cross sectional profile of the interior of the elongated housing enclosed in the container that will slide along the length of the elongated housing when urged and extract the contents of the container completely.

This application is a divisional application of the prior nonprovisional U.S. patent application Ser. No. 10/126,705, filed on Apr. 20, 2002, entitled Container.

### BACKGROUND

1. Field of Invention

The present invention relates to a container for storing viscous substances and is easily transportable. The viscous substances contained within the container can be extracted easily and completely without using any tools and without contact with the user.

2. Description of Related Art

Containers that enclose viscous substances to be stored and transported are often inconvenient to use and most requires an applicator or other tools to extract the viscous substance. One conventional design utilizes a soft container that can be squeezed to extract the content through an opening that is generally sealed with a screwed-on cap. This design requires that the user first unscrew the cap to expose the opening and then apply pressure to the body of the container to force the content out through the opening. This design does not allow complete extraction of the content of the container due to the fact that as pressure is applied to the body of the container, the content would spread out and some would always remain in the container even if the container is almost empty.

Another design uses a pump mechanism to physically pump the viscous substance through an opening that operates in conjunction with the pump mechanism such that as the pump mechanism is operated, the opening would open to allow the content to be extracted. This design is expensive to manufacture, and requires many small parts to be assembled.

### BRIEF SUMMARY OF THE INVENTION

The present invention is a container that stores viscous substances in a sealed environment and is easily transportable. The contents of the container can be easily extracted completely without any tools or contact with the user.

The present invention is an elongated container with one or more opening near its ends and with one or more piston with approximately the same profile and dimension as the cross sectional profile of the interior of the elongated housing enclosed in the container that will slide along the length of the elongated housing when urged and extract the contents of the container completely.

### BRIEF DESCRIPTION OF THE DRAWINGS

FIG. 1 shows the preferred embodiment of the container with two openings, one near each and of the elongated housing, and two pistons enclosing a viscous substance.

FIG. 2 shows another embodiment of the container with two openings that are sealed with covers, one near each end of the elongated housing, and two pistons enclosing a viscous substance.

FIG. 3 shows another embodiment of the container with one opening near one end of the elongated housing and a piston enclosing a viscous substance against the unopened end of the elongated housing with a scoring near the unopened end.

FIG. 4 shows another embodiment of the container with one opening that is covered near one end of the elongated housing and a piston enclosing a viscous substance against the unopened end of the elongated housing with a scoring near the unopened end.

FIG. 5 shows another embodiment of the container with two openings, one near each end of the elongated housing, and two pistons located at the same location as the openings and sealing the openings, enclosing a viscous substance.

FIG. 6 shows the position of the pistons after they are urged away from the openings to extract the contents of the elongated housing.

FIG. 7 shows another embodiment of the container with two openings, one near each end of the elongated housing, and two pistons retained in a retained position by restrictor and enclosing a viscous substance.

FIG. 8 shows the position of the pistons after they are urged away from their retained position to extract the contents of the elongated housing.

FIG. 9 shows another embodiment of the container with two openings that are covered, one near each end of the elongated housing, and two pistons retained in a retained position by restrictor and enclosing a viscous substance.

FIG. 10 shows the position of the pistons after they are urged away from their retained position to extract the contents of the elongated housing.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

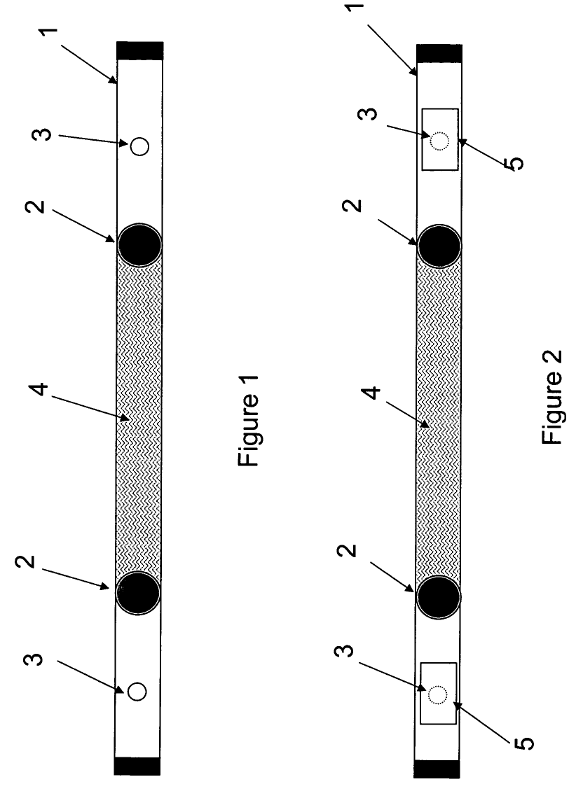

FIG. 1 shows the preferred embodiment of the container. The container has an elongated housing 1 with two ends. An opening 3 is located near each of the two ends. Two pistons 2 are enclosed within the elongated housing 1 with approximately the same profile and dimension as the interior profile and dimension of the elongated housing 1 and located between the two openings 3. The two pistons 2 enclose and seal a viscous substance 4 between them within the elongated housing 1. The viscous substance 4 is sealed within the elongated housing 1 until the pistons 2 are urged either by air pressure or physical force to move from their initial position.

The user may simply cover one of the opening 3 with their finger and apply pressure to the air chamber in the elongated housing 1 under the opening 3 at one end to generate an air pressure that will urge the pistons 2 to slide toward the other opening 3 at the opposite end of the elongated housing 1. Since fluids are incompressible, the viscous substance 4 will slide along the elongated housing 1 at the same rate and distance as the pistons 2. Once the piston 2 at the opposite end of the elongated housing 1 slides pass the opening 3 at the opposite end of the elongated housing 1, the viscous substance 4 will exit through the opening 3 at the opposite end of the elongated housing 1 for application. The piston 2 will also scrape the interior surfaces of the elongated housing 1 to completely extract all viscous substances 4 as it slides along the elongated housing 1. The user may also simply apply physical force by squeezing one end of the elongated housing 1 and physically push the piston 2 to slide toward the other end of the elongated housing 1 to achieve the same result.

FIG. 2 shows another embodiment of the container of FIG. 1 wherein each of the two openings 3 of the preferred embodiment is covered with a cover 5. The cover 5 will further seal the air chambers under the openings 3 to prevent contaminants from entering into the elongated housing 1 and results in a completely sealed elongated housing 1.

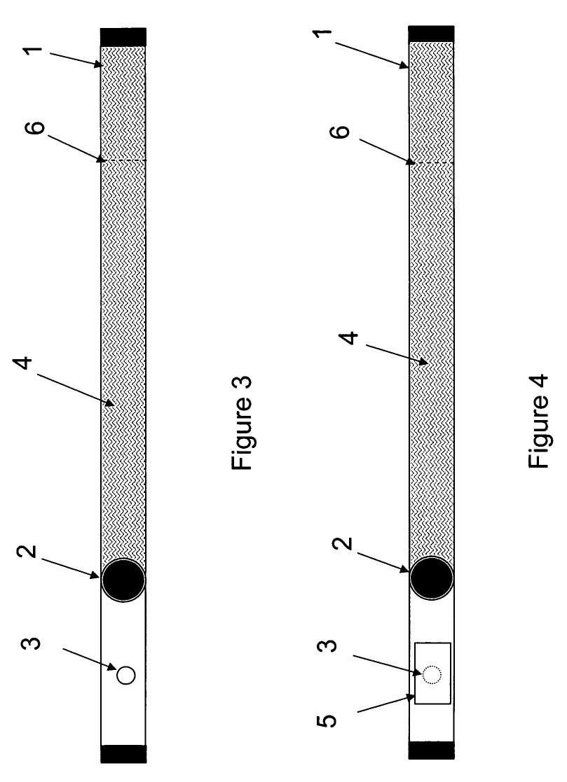

FIG. 3 shows another embodiment of the container. The container has an elongated housing 1 with two ends. An opening 3 is located near one end of the elongated housing 1. A piston 2 is enclosed within the elongated housing 1 with approximately the same profile and dimension as the interior profile and dimension of the elongated housing 1 and located near the same end as the opening 3. The piston 2 encloses and seals a viscous substance 4 between the piston 2 and the other end of the elongated housing 1 without any openings but with a scoring 6 such that the elongated housing 1 can be broken open at the scoring 6 when bent. The viscous substance 4 is sealed within the elongated housing 1 until the elongated housing 1 is broken open at the scoring 6 and the piston 2 is urged either by air pressure or physical force to move from its initial position to force the viscous substance 4 out of the elongated housing 1.

Another variation of the embodiment of the invention shown in FIG. 3 utilizes a pressure sensitive opening instead of a scoring 6 such that when the piston 2 is urged either by air pressure or physical force to move from its initial position to force the viscous substance 4 against the other end of the elongated housing 1 that is sealed with the pressure sensitive opening, the pressure sensitive opening will open due to the resulting pressure and allow extraction of the viscous substance 4 from the container. The pressure sensitive opening may be created by sealing the end of the elongated housing 1 with just sufficient force to prevent the viscous substance 4 from leaking from the elongated housing 1 but will break the seal if a predetermined amount of pressure is applied to the pressure sensitive seal.

FIG. 4 shows another embodiment of the container of FIG. 3 wherein the opening 3 is covered with a cover 5. The cover 5 will further seal the air chamber under the opening 3 to prevent contaminants from entering into the elongated housing 1 and results in a completely sealed elongated housing 1.

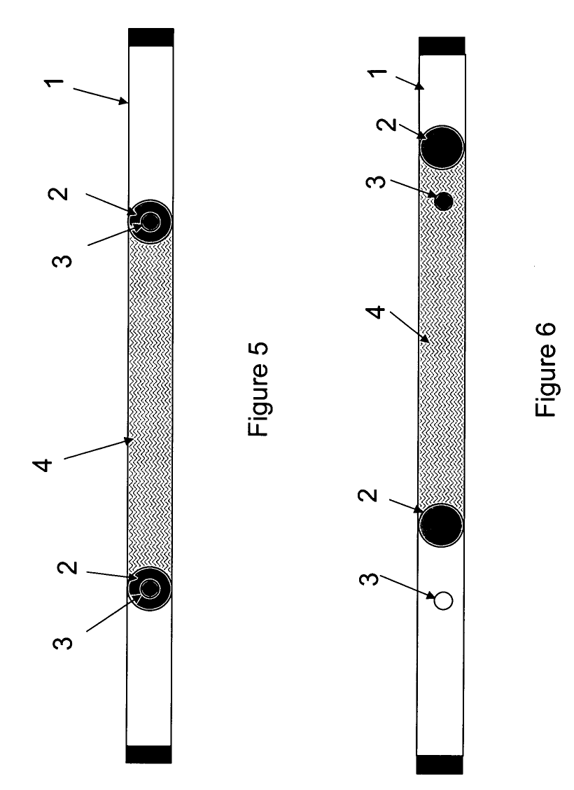

FIG. 5 shows another embodiment of the container. The container has an elongated housing 1 with two ends. An opening 3 is located near each of the two ends. Two pistons 2 are enclosed within the elongated housing 1 with approximately the same profile and dimension as the interior profile and dimension of the elongated housing 1 with one piston located under each of the openings 3 thereby sealing the openings 3. The two pistons 2 enclose and seal a viscous substance 4 between them within the elongated housing 1. The viscous substance 4 is sealed within the elongated housing 1 until the pistons 2 are urged either by air pressure or physical force to move from their initial position as shown in FIG. 6. When the user squeezes either end of the elongated housing 1, the resulting pressure will urge the pistons 2 to slide away from their initial position toward the other end of the elongated housing 1. Since fluids are incompressible, the viscous substance 4 will slide along the elongated housing 1 at the same rate and distance as the pistons 2. Once the piston 2 at the opposite end of the elongated housing 1 slides away from the opening 3 at the opposite end, the viscous substance 4 will exit through the opening 3 at the opposite end of the elongated housing 1 for application. The piston 2 will also scrape the interior surfaces of the elongated housing 1 to completely extract all viscous substances 4 as it slides along the elongated housing 1.

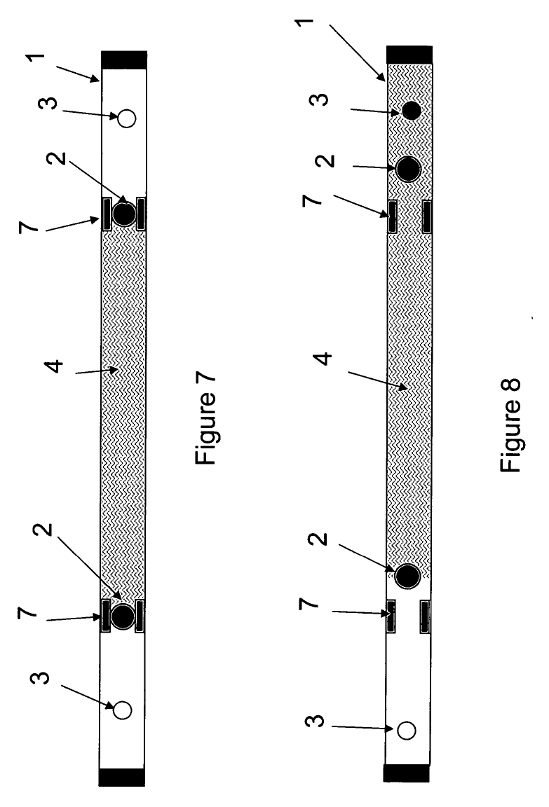

FIG. 7 shows another embodiment of the container. The container has an elongated housing 1 with two ends. An opening 3 is located near each of the two ends. Two pistons 2 are enclosed within the elongated housing 1 with a smaller dimension than the interior dimension of the elongated housing 1 and retained at their predetermined locations by a restrictor 7 and located between the two openings 3. The two pistons 2 enclose and seal a viscous substance 4 between them within the elongated housing 1. The viscous substance 4 is sealed within the elongated housing 1 until the pistons 2 are urged either by air pressure or physical force to move from their predetermined position at the restrictor 7. Once the pistons 2 separate from the restrictor 7 they will allow free movement of the viscous substance 4 within the elongated housing 1. As shown in FIG. 8, depending on the orientation of the container, the viscous substance 4 may exit from either opening 3.

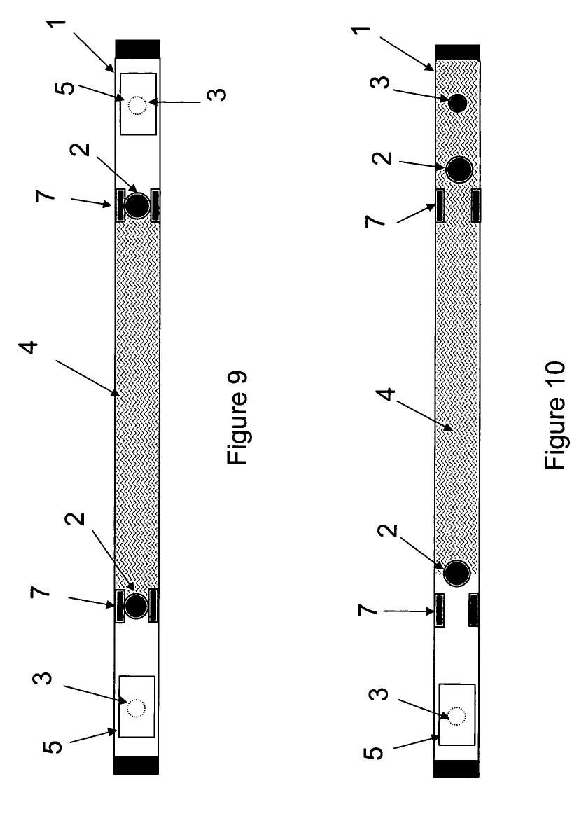

FIG. 9 shows another embodiment of the container of FIG. 7 wherein each of the two openings 3 is covered with a cover 5. The cover 5 will further seal the air chambers under the openings 3 to prevent contaminants from entering into the elongated housing 1 and results in a completely sealed elongated housing 1. Furthermore, the resulting sealed air chamber may be pressurized to a positive pressure or a negative pressure such that when one cover 5 is removed, the air pressure, whether positive or negative, in the remaining sealed air chamber will urge the pistons 2 to slide away from their initial position at the restrictors 7 and allow free movement of the viscous substance 4 within the elongated housing 1 and exit through the opening 3 as shown in FIG. 10.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A container comprising:
an elongated housing with an opening near one end and an opening means near the other end wherein said elongated housing can be opened at said opening means;
a piston enclosed within said elongated housing with approximately the same profile and dimension as the cross sectional profile of the interior of said elongated housing that will slide along the length of said elongated housing when urged and separating the interior of said elongated housing into chambers;
wherein said piston will retain a viscous substance within said elongated housing separating said viscous substance from said chamber under said opening, when said piston is urged to move from its position said viscous substance will be forced through said opening means in said elongated housing after said elongated housing is opened at said opening means.

2. A container as in claim 1, wherein said opening means is a score line.

3. A container as in claim 1, wherein said opening means is a pressure sensitive opening wherein the container can be forced open at said pressure sensitive opening to allow said viscous substance contained within said elongated housing to be extracted by said piston after it is urged to move from its position.

4. A container as in claim 1, wherein said opening on said elongated housing is covered with a cover.

5. A container as in claim 1, wherein said piston is retained at a retained position at a predetermined location along the length of said elongated housing by a restrictor that reduces the internal cross sectional area of said elongated housing at said predetermined location wherein when said piston is urged to move from its retained position said viscous substance will exit through said opening means in said elongated housing after said elongated housing is opened at said opening means.

6. A container as in claim 5, wherein said opening means is a score line.

7. A container as in claim 5, wherein said opening means is a pressure sensitive opening wherein the container can be forced open at said pressure sensitive opening to allow said viscous substance contained within said elongated housing to be extracted by said piston after it is urged to move from its position.

8. A container as in claim 5, wherein said opening on said elongated housing is covered with a cover.

9. A container as in claim 8, wherein said chamber in said elongated housing is positively pressurized by air pressure wherein when said opening means is opened, the air pressure in said chamber will urge said piston to move from its retained position away from said chamber and force said viscous substance to exit through said opening means.
